(19) United States
(12) Patent Application Publication
(10) Pub. No.: US 2010/0333155 A1
(43) Pub. Date: Dec. 30, 2010

(54) SELECTIVELY USING LOCAL NON-VOLATILE STORAGE IN CONJUNCTION WITH TRANSMISSION OF CONTENT

(76) Inventors: Philip David Royall, Longniddry (GB); Kinshuk Rakshit, Bonnyrigg (GB); Kevin Patrick Kealy, Currie (GB); Fabrice Jogand-Coulomb, San Carlos, CA (US); Itzhak Pomerantz, Kefar Sava (IL)

Correspondence Address: VIERRA MAGEN/SANDISK CORPORATION, 575 MARKET STREET, SUITE 2500, SAN FRANCISCO, CA, 94105, US

(21) Appl. No.: 12/494,758

(22) Filed: Jun. 30, 2009

(51) Int. Cl. H04N 7/173; H04N 5/225; H04L 12/58

(52) U.S. Cl. 725/105; 348/207.1; 455/412.1; 348/E05.024

(57) ABSTRACT

Content is created at a first location using a video camera or other device. At least a subset of the created content is stored in non-volatile storage at the first location. At least a portion of the content stored in the non-volatile storage is transmitted to a remote entity via a network in response to a trigger. For example, a video camera may send video data to a server or other client. If the network becomes unavailable, the camera will store the video in a local flash memory and when the network becomes available, the camera can transmit the video from the flash memory to the server or other client. Alternatively, the camera may transmit low resolution video to the server while storing a high resolution version of the video in the local flash memory. If a trigger event occurs, the camera will then send the appropriate high resolution video the local flash memory to the server. In another alternative, video (or other content) transferred to a mobile device is stored and paused during a telephone call (or other function).

### BACKGROUND OF THE INVENTION

1. Field

The present invention relates to the selective use of non-volatile storage in conjunction with transmission of content.

2. Description of the Related Art

Transmission of content using networks has become more popular as technology advances and the number of applications increase. For example, security cameras now use wireless and wired networks to send video to a central server or monitoring system, live and recorded video is transmitted to mobile and non-mobile computing devices, live and recorded audio is transmitted to mobile and non-mobile computing devices, multiple computing devices connected to a network participate in online games and simulations, etc.

As the popularity for transmitting large amount of content increases, such as streaming video and/or audio, the demands and reliance on the network infrastructure increase in parallel with user's reliance on successful delivery of the content. However, there are times when one or more components of the system delivering the content are not available to participate in the transmission. For example, a network may be malfunctioning or a client computing device may be busy with another tasks. In these instances, it is important that the content to be transferred is not lost.

### SUMMARY OF THE INVENTION

The technology described herein provides a system for selectively using local non-volatile storage in conjunction with the transmission of content

### BRIEF DESCRIPTION OF THE DRAWINGS

FIG. 1 is a block diagram depicting the components of one embodiment of a system for implementing the technologies described herein.

FIG. 2A is a block diagram depicting the components of one embodiment of a camera system.

FIG. 2B is a block diagram depicting the components of one embodiment of a camera system.

FIG. 3 is a block diagram depicting the components of one embodiment of a mobile computing system.

FIG. 4 is a flow chart describing one embodiment of a process of selectively using local non-volatile storage in conjunction with transmission of content.

FIG. 5 is a flow chart describing one embodiment of a process of determining whether a trigger condition has reverted.

FIG. 6 is a flow chart describing one embodiment of a process of determining whether a trigger condition has reverted.

FIG. 7 is a flow chart describing one embodiment of a process of transmitting newly created content and buffered content (if any) to one or more destinations.

FIG. 8A is a flow chart describing one embodiment of a process performed by a server in response to a camera system or other content provider performing the process of FIG. 7.

FIG. 8B is a flow chart describing one embodiment of a process performed by a server in response to a camera system or other content provider performing the process of FIG. 7.

FIG. 9 is a flow chart describing one embodiment of a process of transmitting newly created content and buffered content (if any) to one or more destinations.

FIG. 10 is a flow chart describing one embodiment of a process of selectively using local non-volatile storage in conjunction with transmission of content.

FIG. 11 is a flow chart describing one embodiment of a process of selectively using local non-volatile storage in conjunction with transmission of content.

FIG. 12 is a flow chart describing one embodiment of a process of a mobile client performing a function.

FIG. 13 is a flow chart describing one embodiment of a process of selectively using local non-volatile storage in conjunction with transmission of content.

FIG. 14A is a flow chart describing one embodiment of a process of displaying newly received content and buffered content (if any).

FIG. 14B is a flow chart describing one embodiment of a process of displaying newly received content and buffered content (if any).

FIG. 14C is a flow chart describing one embodiment of a process of displaying newly received content and buffered content (if any).

### DETAILED DESCRIPTION

A system is provided that selectively uses local non-volatile storage in conjunction with transmission of content. For example, in a system that is streaming (or transmitting in another manner) video and/or audio (or other content) from a source of the content, while the network is functional that content can be successfully streamed to the destination. If the network becomes unavailable, then the content is stored in local non-volatile storage system until the network becomes available. When the network becomes available, the content on the non-volatile storage system will be transmitted to the destination in addition to newly created content.

In another embodiment, a low resolution version of content is transmitted to a destination and a high resolution version is stored in local non-volatile storage until a trigger occurs. In response to the trigger, one or more portions of the high resolution version can be transmitted to the destination. Examples of a trigger include the destination sending a request, something is recognized in the content or a predetermined condition occurs.

In another embodiment, a mobile computing device that is presenting the transmitted content may become busy with another task. To prevent the content from being lost and to make the presentation of the content as seamless as possible, the mobile computing device can buffer the received content in local non-volatile storage until the other task is completed. Upon completion of the task that time, the mobile computing device can resume presenting the content at the point where it left off prior to the task.

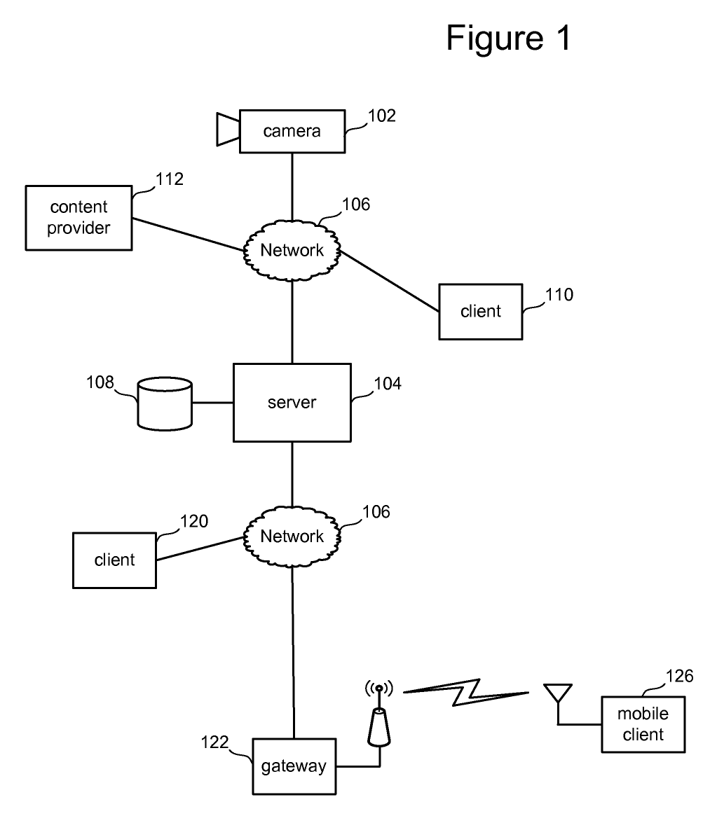

FIG. 1 is a block diagram depicting the components of one embodiment of a system for implementing the technologies described herein. FIG. 1 shows camera 102 in communication with server 105 and client 110 via network 106. Server 104 includes data store 108 for storing video (or other content). In one embodiment, camera 102 captures video and streams that video to server 104 and/or client 110. The technology described herein can be used with content other than video. For example, FIG. 1 shows other content provider 112 also in communication with server 104 and/or client 110 via network 106. Content provider 112 can be any entity or system that creates content and provides that content to one or more other entities via a network or other communication means. Content provider 112 can include a microphone, musical instrument, computing device, telephone, audio recorder, temperature sensor, humidity sensor, motion sensor, orientation sensor, etc.

Network 106 can be a LAN, a WAN, the Internet, another global network, wireless communication means, or any other communication means. No particular structure is required for network 106.

Client 110 can be any type of computing device including mobile and non-mobile computing devices. Examples of client 110 include desktop computer, laptop computer, personal digital assistant, cellular telephone, smart phone, smart appliance, etc. No particular type of client is required.

Server 104 can be any standard server known in the art that can communicate on one or more networks, store and serve data, and implement one or more software applications. FIG. 1 also shows server 104 communicating with client 120 and gateway 122 via network 106. The icon for network 106 is shown twice in FIG. 1 to make FIG. 1 easier to read. However, it is anticipated that there is only one instance of network 106. However, in other embodiments server 104 can communicate with client 120 and gateway 122 via a different network. Server 104 stores content received from camera 102 or content provider 110 in data store 108 and serves that content to either client 120 or client 126 (via gateway 122). Client 120 can be any type of computing device listed above. Gateway 122 is a data processing system that receives data from server 104 and provides that data to mobile client 126 via wireless communication means. In one embodiment, mobile client 126 is a cellular telephone or smart phone. Other types of mobile computing devices can also be used.

In one embodiment, camera 102 captures video (and/or audio) and streams that video to server 104, which stores the video in data store 108. Client 120 and/or mobile client 126 can contact server 104 and have the video streamed from server 104 to client 120 or mobile client 126. In one embodiment, server 104 will stream the video to the client by reading the video from data store 108. In another embodiment, server 104 will stream the video directly to client 120 and/or client 126 as it receives it from camera 102.

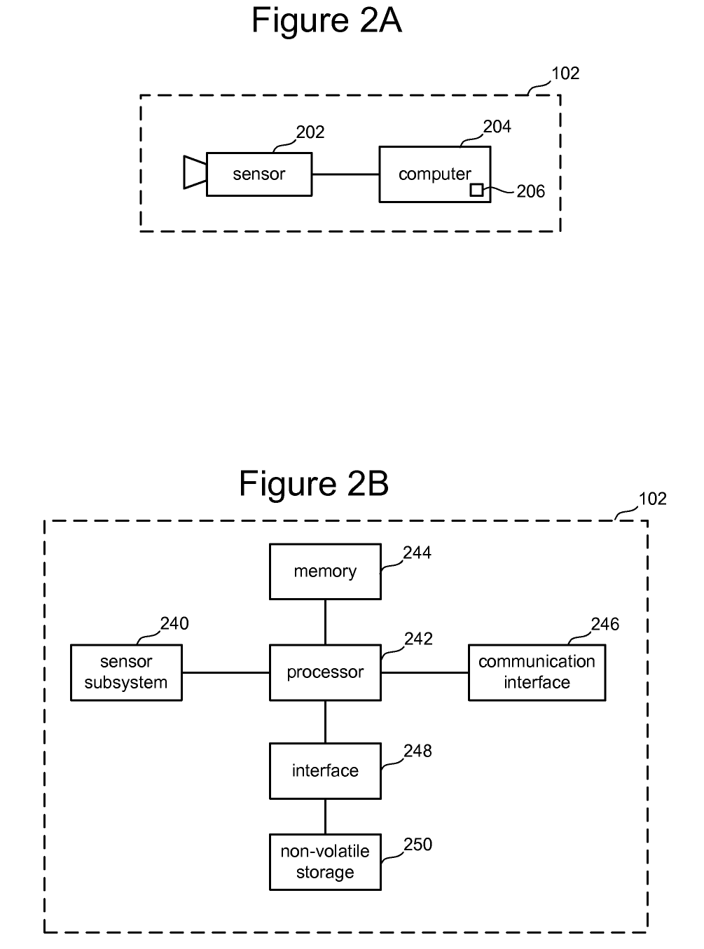

Camera 102 of FIG. 1 can be a standard camera known in the art or a custom camera built to include the particular technology described herein. In some embodiments, camera 102 includes all of the components within the camera itself. In other embodiments, camera 102 is connected to a computing system to provide additional technology. For example, FIG. 2A shows an embodiment where camera 102 includes a sensor 202 connected to a computing device 204.In one embodiment, sensor 202 is a video sensor known in the art that outputs video. For example, sensor 202 can be a standard definition or high definition video camera. Other types of sensors can also be used.

Computer 204 can be a standard computer that includes a processor connected to memory, hard disk drive, network card, one or more input/output devices (e.g. keyboard, mouse, monitor, printer, speaker, etc.) and one or more communication interfaces (e.g., modem, network card, wireless means, etc). Computing device 204 includes a video input port (e.g., a USB port, FireWire port, component video port, S-video port or other) for connecting to and receiving video from sensor 202. In addition, computer 204 includes non-volatile storage 206 (in communication with the processor of computer 204). In one embodiment, non-volatile storage 206 is a flash memory card that can be inserted and removed from computer 204. Example formats for flash memory cards include Compact Flash, Smart Media, SD cards, mini SD cards, micro SD cards, memory sticks, XD carsd, as well as other formats. In some embodiments, other types of non-volatile storage can also be used. Additionally, permanently installed non-volatile memory cards can also be used. Although it is possible to connect computer 204 to senor 202 via a network, in one embodiment, computer 204 is directly connected to sensor 202 so that both components are in close proximity at the same location. In the embodiment of FIG. 2A, sensor 202 will output live video which will be stored in computer 204. Computer 204 can then transmit (e.g. stream) the video to server 104 via a network card that connects computer 204 to network 106.

FIG. 2B is a block diagram of another embodiment of camera 102 in which all the components are part of one system rather than a sensor separate from a computer. The system of FIG. 2B includes a sensor subsystem 240 connected to processor 242. Sensor subsystem 240 can include one or multiple CCDs as well as other types of video sensors. Other types of sensors (e.g. microphones, temperature sensors, humidity sensors, motion sensors, orientation sensors, etc.) can also be used in addition to a video sensor. Processor 242 can be any standard microprocessor known in the art. In some embodiments, processor 242 includes code to program processor 242. Processor 242 is also connected to memory 244, communication interface 246 and non-volatile storage interface 248. Memory 244 can store code for programming processor 242 as well as data for use by processor 242. In one example, video from sensor subsystem 240 can be buffered in memory 244 prior to communication to server 104 (or other destination). Communication interface 246 provides an interface between camera 102 and network 106. In one embodiment, communication interface 246 is an Ethernet network card. However, other types of communication interfaces can also be used (e.g., modem, router, wireless system, etc.). Non-volatile storage interface 248 provides an interface for processor 242 to communicate with non-volatile storage 250. In one embodiment, non-volatile storage 250 is a removable flash memory card (including any of the types listed above). In other embodiments, non-volatile storage 250 can be a different type of non-volatile storage (e.g., solid state, disk based, etc.). In some embodiments, non-volatile storage 250 is removable, while in other embodiments non-volatile storage 250 is permanently installed. In one example implementation, the components of FIG. 2B are implemented on one or more printed circuit boards that are part of a single computing device at one location. In other embodiment, the components of FIG. 2B can be implemented in a different manner. In both of the embodiments of Fogs. 2A and 2B, data from the sensor can be stored in the non-volatile storage prior to any transmission on a network.

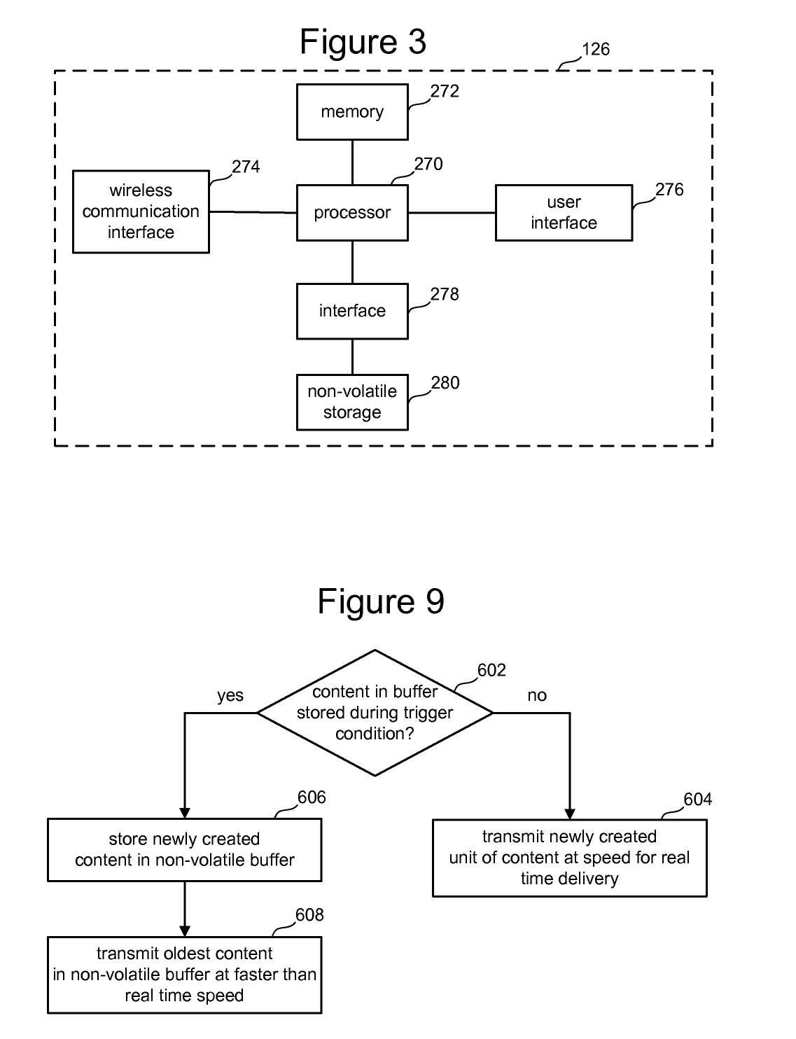

FIG. 3 is a block diagram of one embodiment of the components of mobile client 126. In one example implementation, mobile client 126 is a cellular telephone (including a smart phone). In other embodiments, other types of mobile computing devices can be used. FIG. 3 shows processor 270 in communication with memory 272, wireless communication interface 274, user interface 276, and non-volatile storage interface 278. Processor 270 can be any microprocessor known in the art. Memory 272 is used to store code for programming processor 270 and data used by processor 270. Wireless communication interface 274 includes electronics that enable mobile client 126 to communicate on a cellular telephone network. In other embodiments, wireless communication interface 274 can enable communication via WiFi, RF, or other communication means. No specific type of wireless communication is required. User interface 276 can include a keypad, speaker and/or display (e.g. color LCD display). In some embodiments, user interface 276 can include a touch screen. Interface 278 allows processor 270 to store data in and read data from non-volatile storage 280. In one example implementation, non-volatile storage 280 includes flash memory. In some embodiment, non-volatile storage 280 is a removable flash memory card. In other embodiments, non-volatile storage 280 is not removable. In some implementations, more than one non-volatile storage medium can be used. For example, one medium can be used to store system software and applications, while another medium can be used to store user data. In such an embodiment, the non-volatile storage for storing system software and applications may not be removable, while the non-volatile storage that stores user data may be removable. In other embodiments, both media are removable or neither are removable. Any of the formats described above for removable flash memory can be used. Other types of non-volatile storage can also be used. Although FIG. 2B and FIG. 3 show direct connections between components, one or more buses can be used instead. These figures are simplified for ease of discussion. However, any of various architectures can be used to implement these computing devices.

As discussed above, there are times when one or more components of the system depicted in FIG. 1 are not available to participate in the transmission of the video from camera 102 (or other content from content provider 112) to any of the particular clients/servers depicted. For example, network 106 (or a portion of network 106) may not be available for communication. alternatively, one or more of the clients, or the server, may be busy performing another function (unrelated to the video). In these instances, it is important that the content is not lost.

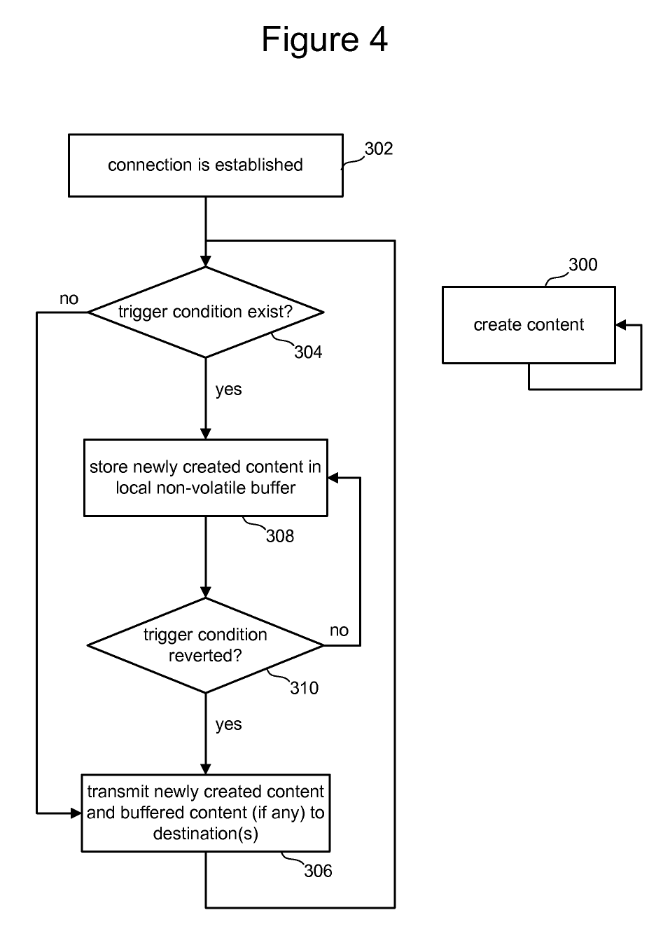

FIG. 4 is a flow chart describing one embodiment of a process for selectively using local non-volatile storage in conjunction with the transmission of content to prevent the content from being lost in case one or more components of the system delivering the content are not available to participate in the transmission. The process of FIG. 4 is performed by the content provider (e.g. content provider 112 or camera 102).

In step 300 of FIG. 4, content is created. For example, camera 102 captures video data. In one embodiment, camera 102 is a video camera that is part of a closed circuit security system that may or may not include other video or still cameras. In other embodiments, other types of content can be created, as described above. In some embodiments, the created content is initially buffered. For example, video can be buffered in memory 240 of camera 102. Other types of buffering can also be performed. FIG. 4 shows an arrow from step 300 back to step 300 to indicate that, in one embodiment, the content is continuously created. In other embodiments, the content may not be continuously created. Step 300 is not connected to the other steps (e.g. steps 302-310) to indicate that step 300 can be performed concurrently with the process of steps 302-310.

In step 302, a connection is established between the appropriate content provider (e.g., camera 102 or content provider 112) and the destination of the content For example, a connection can be created between server 104 and camera 102, client 110 and camera 102, server 104 and content provider 112, client 110 and content provider 112, or other groups of entities. In some embodiments, content (including video) can be transmitted (e.g. streamed) from the content provider (e.g., camera 102 or content provider 112) to the destination of the content without having a connection. Various well known connection-less protocols (e.g., UDP) can be used to transmit content. In cases when a connection-less protocol is used, step 302 can be skipped.

In step 304, it is determined whether a trigger condition exists. In one embodiment, the trigger condition is network 106 not being available for camera 102 to transmit data to the intended destination. Thus, in one embodiment step 304, camera 102 will determine whether the network is available for transmission of newly captured video. In one embodiment, as part of the communication protocols, server 104 (or another client) will send acknowledgements back to camera 102 of the various data packets or segments transmitted. If a particular acknowledgement is not received within a predetermined period of time, camera 102 may determine that the network is no longer available. In some embodiments, camera 102 may receive an error message back when trying to communicate on network 106. In another embodiment, camera 102 may attempt to send a message to server 104 for purposes of seeing whether server 104 is still available for communication. For example, a “ping” function can be used periodically by camera 102 to see if camera 102 can still communicate with server 104 via network 106. In another embodiment, server 104 may periodically send a communication to camera 102 indicating that communication is still available. If a predetermined period of time occurs without that message from server 104, camera 102 can assume that network 106 is not available for communication to server 104. Other means for determining that network 106 is not available for communication to server 104 can also be used. In addition, other trigger conditions can also be used. Another example of a trigger event could be loss of power. In one embodiment, camera 102 will include a battery backup that allows for a full solution against power loss. Battery backups are well known in the art. Other examples of trigger conditions can be predetermined time periods, detection of motion in the video or elsewhere, recognition of nay object in the video, detection of a temperature or other atmospheric conditions, etc.

If the content provider (e.g., camera 102 or content provider 112) determines that there is no trigger condition (e.g. network is not down), then in step 306, the content provider will transmit the newly created content to the destination (e.g. server 104 and/or client 110). In one embodiment, while the network is still up, camera 102 will stream video to server 104. Server 104 can then forward the stream to client 120 or client 126, and/or store the video in data storage 108 for future access by client 120 or client 126. As long as the trigger event does not occur, then the content provider (e.g., camera 102 or content provider 112) will continue to perform step 306 and transmit the newly created content.

When the content provider (e.g., camera 102 or content provider 112) does detect the trigger event, then newly created content will be stored in a local non-volatile buffer. For example, camera 102 will store video in flash memory 206 or flash memory 248. In one embodiment, the non-volatile buffer is operated as a circular buffer so that when the buffer becomes full, the oldest data is replaced first. Because the non-volatile storage is local (e.g. in the same location), there is no need for use of a network to move the content from the content creation device (e.g. camera 102) to the non-volatile storage. Thus, the data is stored prior to any network transmission of the content.

In step 310, it is determined whether the trigger condition reverted. In one embodiment, step 310 includes determining whether the network is now available. If the network is still not available (or other trigger condition has not been reverted), then the process loops back to step 308 and the newly created content (see step 300) is stored in the local non-volatile buffer. Thus, while a trigger condition exists, data is continuously created in step 300 and subsequently stored (as it is created) in the local non-volatile storage in step 308. In one embodiment, the content is stored in the non-volatile memory only during the trigger condition, while in other embodiments the data is stored during the trigger condition and (in some cases) when there is no trigger condition. For example, some embodiments may always buffer the content in the non-volatile storage. If, in step 310, it is determined that the trigger condition no longer exists, then the process continues at step 306 and the newly created content (from latest iteration of step 300) and the content stored in the local non-volatile buffer during the trigger condition is transmitted to the appropriate destination (e.g. server 104 and/or client 110). The content can be transmitted in step 306 by being pushed from camera 102 or content provider 112 (e.g. streamed) using UDP or another protocol. In another embodiment, when the trigger condition is reverted, server 104 and/or client 110 can request the specific data that was stored in the local non-volatile buffer. More details of step 306 are provided below.

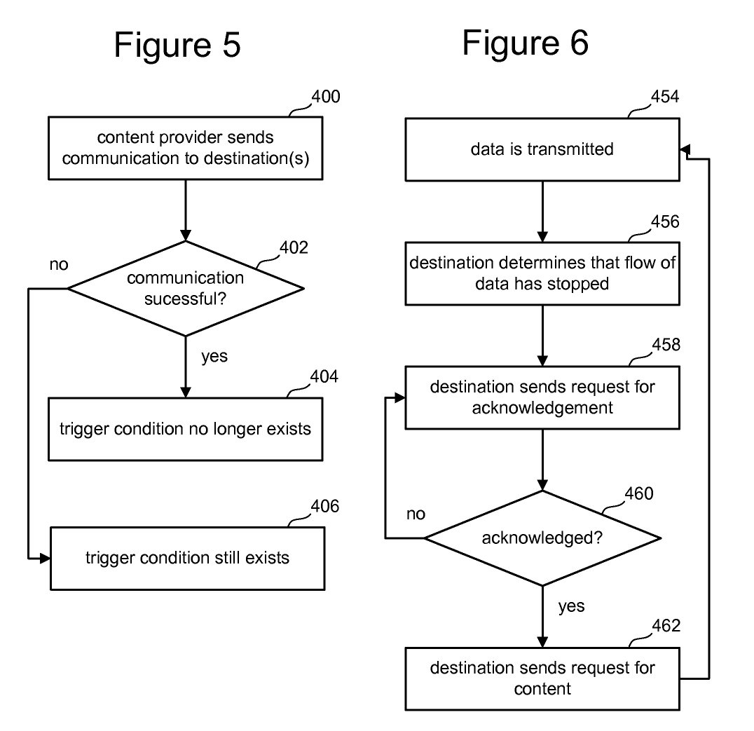

Step 310 of FIG. 4 includes determining if the trigger condition no longer exists. In one embodiment, the content provider (e.g., camera 102 or content provider 112) will determine if the trigger condition no longer exists. In another embodiment, server 104 (and/or client 110) can determine that the trigger condition no longer exists. FIG. 5 is a flow chart describing one embodiment in which the content provider (e.g., camera 102 or content provider 112) determines that the trigger condition no longer exists. FIG. 6 is a flow chart describing one embodiment of server 104 (and/or client 110) determining that the trigger condition no longer exists. Both FIGS. 5 and 6 pertain to the embodiments where the trigger condition is the network being unavailable for communication. Other processes can be used for other trigger conditions.

In step 400 of FIG. 5, the content provider (e.g. content provider 112 or camera 102) sends a communication to the destinations (e.g. server 104 and/or client 110). One example is to send a “ping” message to server 104 and/or client 110. If the communication was successful (step 402), the content provider concludes that the trigger condition no longer exists. For example, if server 104 responds to the ping with the appropriate response, camera 102 will determine that the network is back up. If the communication is not successful (step 402), then the content provider determines that the trigger condition still exists.

FIG. 6 is a flow chart describing one embodiment of a process that includes the server determining that the trigger condition has been reverted. In step 454, data is transmitted from the content provider to the destination (server 104 or client 110). Step 450 is part of step 306 of FIG. 4. In step 456, the destination determines if the flow of data has stopped. For example, server 104 will determine that it has stopped receiving video from camera 102. In step 458, the destination sends a request to the content provider for acknowledgement of the request. For example, server 104 can send a “ping” to camera 102. If the request is not acknowledged, then it is assumed that the network is still not available and the process will loop back to step 458 and repeat step 458. If the request is acknowledged (step 460), then the destination will send a request for content to the content provider. For example, server 104 may send a request for video to camera 102. On the other hand, simply sending the ping successfully could cause the content provider to start sending the data without the request in step 462. In some embodiments, camera 102 will only start sending data to server 104 in response to a request. For example, step 302 or step 304 of FIG. 4 can be performed in response to a request for data from server 104 or client 110.

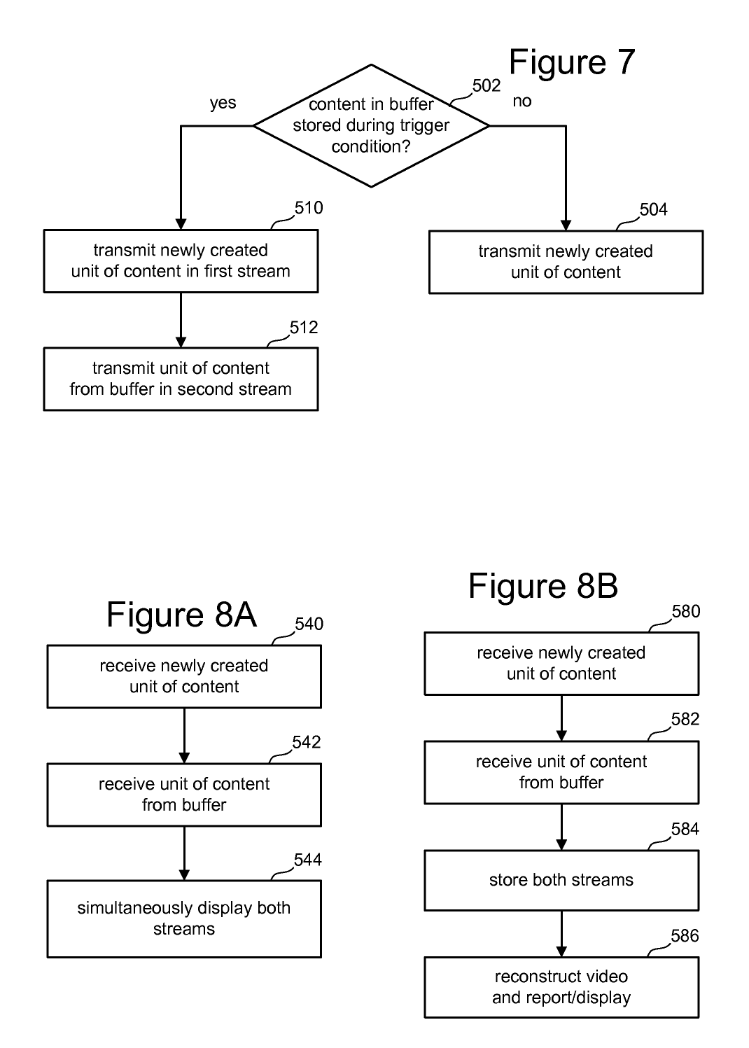

FIG. 7 is a flow chart describing one embodiment of a process for transmitting newly created content and buffered content (if any) to one or more destinations. The process of FIG. 7 is one example for implementing step 306 of FIG. 4. In step 502 of FIG. 7, the content provider (e.g. content provider 112 or camera 102) will determine whether there is any content in the local non-volatile buffer (e.g. non-volatile storage 206 or 248). If the local non-volatile buffer does not include any content that was stored during a trigger condition then in step 504, then the content provider will transmit the newly created unit of content to the destination. This is a situation where there is no data in the buffer that was stored during the trigger condition (possibly because there was no trigger condition), therefore, camera 102 will just stream live content. If, the content provider determines that there is content in the buffer that was stored during a trigger condition, that stored content needs to be sent to the destination (e.g. server 104 and/or client 110). There are many ways to transmit that stored content. In the embodiment of FIG. 7, content from the local non-volatile buffer is interspersed with live content and sent to the server (and/or client 110). Thus, in step 510, the content provider will transmit the newly created unit of content in a first stream. In step 512, the content provider will transmit a unit of content from the buffer in a second stream. In one embodiment, the content provider sends the newest data in the buffer. In another embodiment, the content provider sends the newest data in the buffer. In one alternative to sending the content in two streams, the content from the buffer and the newly created content can be interspersed in one stream.

FIGS. 8A and 8B are flow charts describing two embodiments for actions performed by server 104 or client 110 when receiving the interspersed data sent by camera 102 using the process of FIG. 7. In step 540 of FIG. 8A, the destination (server 104 and/or client 110) receives the newly created unit of content (sent in step 510). In step 542, the destination receives the unit of content from the buffer (sent in step 512). In step 544, both units of content will simultaneously be displayed to a user via a monitor or other display device. For example, client 110 could put up two windows and simultaneously display both streams. Therefore, the user will simultaneously see live video as well as stored video. Additionally, both streams can be stored on the destination.

In step 580 of FIG. 8B, the destination (server 104 and/or client 110) receives the newly created unit of content sent in step 510. In step 582, the destination receives a unit of content from the buffer sent in step 512. In step 584, both streams will be stored. In step 586, the destination reconstructs the entire video from both streams. In one embodiment, steps 580-584 can be repeated many times prior to performing step 586 so that the destination will recreate the video for future display or transmission after all the data from the buffer is received and stored.

FIG. 9 is a flow chart describing another embodiment of a process for transmitting newly created content and buffered content (if any) to one or more destinations. FIG. 9 is alternative to FIG. 7 for implementing step 306 of FIG. 4. In step 602, the content provider (e.g. content provider 112 or camera 102) determines whether there is any content in the buffer that was stored during a previous trigger condition. If not, then a newly created unit of content is transmitted to the destination at in real time delivery. In one embodiment, step 604 includes camera 102 streaming video in real time to server 104. If, in step 602, the content provider determines that there is content in the buffer that was stored during a trigger condition, then camera 102 will store the newly created content in the local non-volatile buffer in step 606. In step 608, camera 102 will transmit to the destination the oldest content that is stored in the local non-volatile buffer. This content will be transmitted at a speed faster than real time speed. Thus, while there is content stored in the buffer from the trigger condition, new content will be placed in the buffer and old content will be transmitted to server 104 or client 100 at a faster rate until the buffer is empty (e.g. the camera caught up with live video). After the buffer is empty, the new content is transmitted in real time.

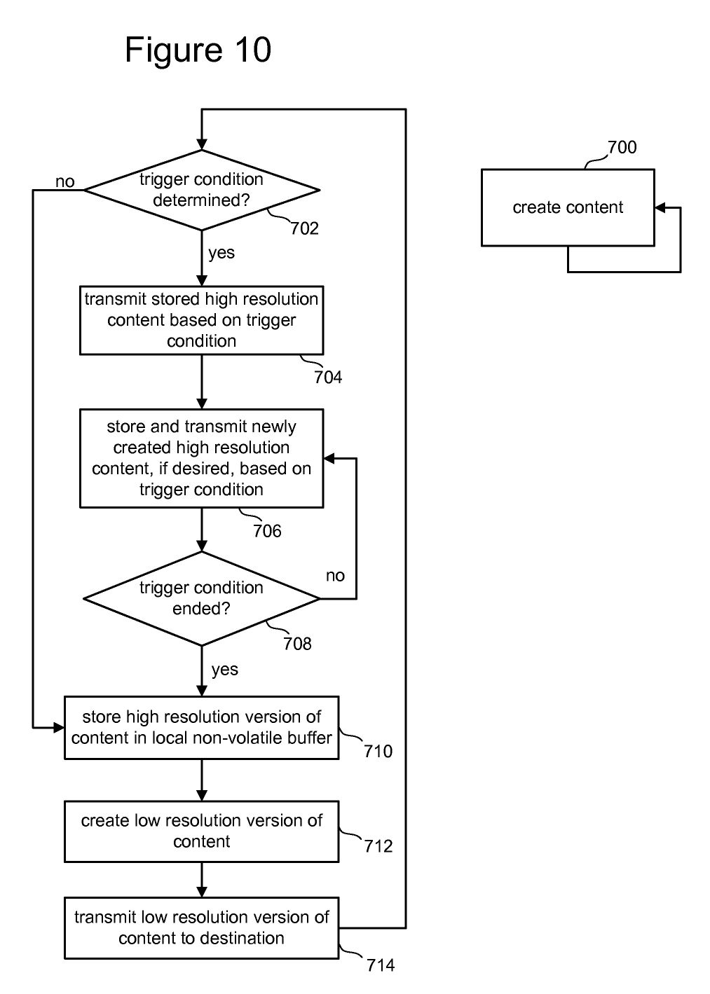

As described above, in one embodiment, a low resolution version of content is transmitted to a destination and a high resolution version of that content is stored in the local non-volatile storage. When a trigger occurs, one or more portions of the high resolution version can be transmitted to the destination. FIG. 10 is a flow chart describing such a process.

FIG. 10 shows step 700, in which new content is continuously created. Step 700 is not connected to steps 702-714 to indicate that step 700 can be performed concurrently with steps 702-714. In step 702, the content provider that is creating the content (e.g. camera 102 or other content provider 112) will determine whether a trigger condition has occurred. One example of a trigger condition for FIG. 10 is whether a preset time has been reached. Alternatively, in the case of video, a trigger condition can be camera 102 identifying a shape or object in the video using well known processes for pattern recognition. In another embodiment, the trigger can be a change in atmospheric conditions (e.g., a change in lighting, temperature humidity, etc.) If the content is audio, the content provider can identify indicia in the audio or indicia in other types of content. Another example of a trigger condition is a message from server 104 or client 110. For example, server 104 can request that camera 110 start sending high resolution video now or can request a specific range (e.g. time or frame numbers) of high resolution video. If the trigger condition did not occur (step 702), then in step 710, the content provider will store a high resolution version of the newly created content in a local non-volatile buffer. In one embodiment, the storing of content in step 710 is performed prior to any network transmission of the content being stored. In step 712, the content provider will create a low resolution version of the content. In one implementation, the output of camera 102 is high resolution video. In step 712, processor 242 or computer 204 will create a low resolution version of the video using processes well known in the art. In step 714, the low resolution version of content created in step 712 will be transmitted to the destination (e.g. server 104 and/or client 110). After step 714, the process loops back to step 702.

If the content provider determines that the trigger did occur (see step 702), then in step 704 the appropriate high resolution content stored in the local non-volatile buffer will be transmitted to the destination based on the trigger. In step 706, the content provider stores and transmits to the destination the newly created content. For example, if the trigger is identifying motion, then camera 102 starts sending a high resolution version of the video to server 104 going forward for the next two minutes in step 706. Additionally, camera 102 will transmit the previous five seconds of video in high definition video a part of step 704. In another example, the trigger may include the server requesting a particular portion of video at high resolution. Thus, in step 704, camera 102 will send the appropriate time period of high resolution video stored in the local non-volatile buffer. Step 706 includes storing and transmitting newly created high resolution content, if desired, based on the trigger. Some triggers will only require previously stored content to also be sent to the destination (step 704), some triggers may only require newly created content (from step 300) to also be sent to the destination (step 706), and some triggers may require previously stored content and newly created content to also be sent to the destination (steps 704 and 706).

If the trigger is not over (step 708), then the process loops back to step 706 to continue sending newly created content (from step 300). When the trigger does end (step 706), then the content provider will go back to storing the high resolution version of the content in step 710 and creating a low resolution version of the content for transmission in step 712. The process will then continue as discussed above.

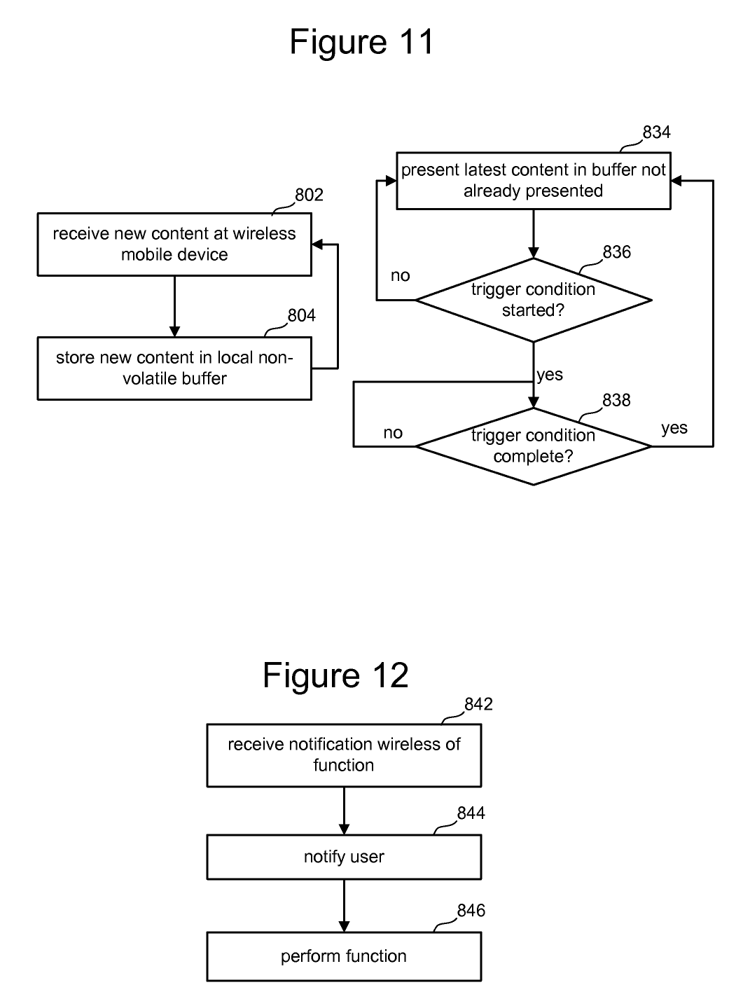

FIGS. 1 and 3 depict mobile client 126. Content from camera 102 or other content provider 112 can be provided to gateway 112 for transmission to mobile client 126. For example, video can be streamed from camera 102 (via server 104 of directly from camera 102) to mobile client 126 for presentation to a user of mobile client 126 via user interface 276 (LCD display screen). If, during this streaming (or other type of transmission) mobile computing device 126 needs to perform a different function (not related to the streaming) such that mobile computing device 126 will not be able to continue presenting the content to the user via the user interface 276 or the user will not be able to properly pay attention to the content, the mobile computing device can buffer the received content in its local non-volatile storage 280 (see FIG. 3) in order to store the video so that it can be presented to the user when the function is over. FIG. 11 provides one embodiment of such a process. In step 802 of FIG. 11, mobile computing device 126 will receive new content. This content is received via wireless transmission (depicted in FIG. 1) using wireless communication interface 274 (depicted in FIG. 3). In step 804, that new content is stored in the local non-volatile buffer. Steps 802 and 804 are repeated until the streaming or other transmission is completed. Thus, in the embodiment of FIG. 11, content is always first stored in the non-volatile buffer. In other embodiments, content can be stored in a different type of buffer.

In step 834, mobile client 126 present the newest content that is stored in its buffer to the user via user interface 276. If there has not been a trigger condition, this could be presenting real time video to a user of a mobile telephone. There is no line connecting steps 804 to 834. This is because steps 802 and 804 are performed while concurrently performing the process of steps 834-838. In step 836, mobile client 126 determines whether a trigger condition has started. If not, the process loops back to step 834 and the latest content in the local non-volatile buffer that has not already been presented is then presented to the user via the user interface 276. If a trigger condition has started, then in step 838 it is determined whether the trigger condition has completed. If the trigger condition has not completed, then the mobile client 126 will continue to check for whether the trigger condition has completed. In one embodiment, mobile client 126 can continue to present the latest video but not mark it as already presented. Once the trigger condition completes in step 838, then the process loops back to step 834 and mobile client 126 will again start presenting the latest content in the buffer that has not already been presented. This contemplates that when the process loops from step 838 to step 834, mobile client 126 will start playing video from a point in time when the trigger condition was detected to have started in step 836. One example of a trigger condition is a telephone call. When a user receives a telephone call, upon the establishment of the voice connection for that telephone call, the video will no longer be presented to the user. Once the telephone call completes (the trigger condition completes), then the mobile telephone will start presenting video from the point at which the telephone call started. During the telephone call, the display screen can be off, paused or performing other functions.

FIG. 12 is flow chart describing one embodiment of a process performed by mobile client 126 when performing another function, where the performance of the other function is the trigger condition described above in step 836 and step 838. The process of FIG. 12 can be performed concurrently with the process of FIG. 11 or sequentially, as appropriate in the particular instance. In step 842, mobile client 126 will receive a notification of the function. In one embodiment, the notification is received wirelessly. In other embodiments, the notification can be received via other means which is not wireless. For example, the notification can come from user interface 276. For example, if the function being performed is a telephone call, then in step 842 the mobile telephone will wirelessly receive notification of an incoming telephone call via the cellular network. In step 844, mobile client 126 will notify the user of the function, if appropriate. For example, if the function is a telephone call, the user will be provided with a display indicating that an incoming call is coming. In some embodiments, caller ID will be used to identify the caller. Additionally, an audio alert can be provided to the user. In step 846, the function is performed by mobile client 126. In some examples, the function is unrelated to the transmission of content. For example, if the user is streaming video, a telephone call is unrelated to the streaming of video. Other examples of functions that are not related to streaming video could be use of any of the functions of a PDA or applications on a smart phone, etc.

The trigger condition discussed above can be the performance of the function. The start of the trigger condition (see step 836 of FIG. 11) can be the start of performing the function. Alternatively, the trigger condition can start upon receipt of notification of the function (step 842 of FIG. 12) or upon notifying the user (step 844 of FIG. 12). The trigger condition will be completed upon completion of the performance of the function (step 846 of FIG. 12). For example, a trigger condition can start when the telephone receives an indication that there is an incoming call, when the user is provided with a visual or audio indication of an incoming call, or when the user starts the telephone call. The function can also include the performance of a different type of voice connection other than a standard telephone call. For example, the function could be performing voice over IP (VOIP”). Other functions can also be used.

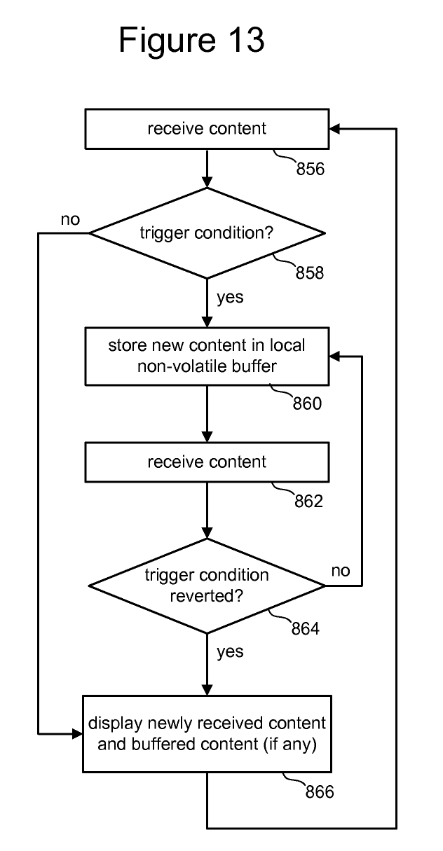

In the embodiment of FIG. 11, content received wirelessly at mobile client 126 was always first stored in the non-volatile buffer. FIG. 13 is a flow chart providing a process in which content received when there is no trigger condition is not stored on the non-volatile buffer and content received during the trigger condition is stored on the non-volatile buffer. In step 856 of FIG. 13, mobile client 126 receives content wirelessly. For example, a mobile telephone receives streaming video from server 104 via network 106 and/or gateway 122 (wireless communication). In step 858, mobile client 126 determines whether the trigger condition exists. If the trigger condition does not exist, then the content received in step 856 is displayed in step 866. Content that was just received and immediately displayed is said to be displayed in real time with respect to when it was received by mobile computing device 126. Any content that is also buffered (if any) can also be displayed in step 866, as described below. After step 866, the process loops back to step 856.

If, in step 858, it is determined that the trigger condition does exist, then in step 860 the new content received in step 856 is stored in the local non-volatile storage 280. In step 862, new content is received by mobile client 126. In step 864, it is determined whether a trigger condition has reverted (no longer exists). If the trigger condition still exists, then the process loops back to step 860 and the newly received content is stored in local non-volatile storage 280. If the trigger condition has reverted (step 864), then the newly received content and buffer content stored in local non-volatile storage 280 is displayed to the user in step 866.

When the mobile client 126 starts playing video after the trigger condition is over, it is playing video that is delayed in time with respect to when it was received. For example, prior to a telephone call the user is watching video in real time, during the telephone call video is stored, and subsequent to the telephone call, the stored video (which is delayed in time with respect to when it was received by the telephone) is then displayed to the user.

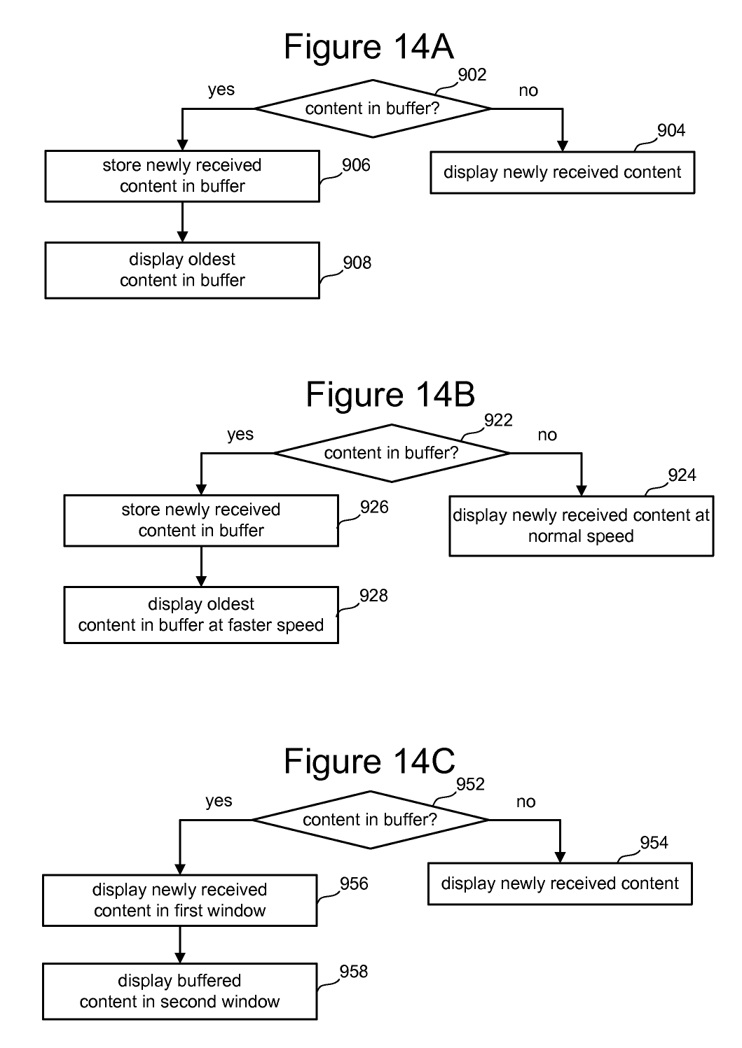

FIGS. 14A, 14B and 14C provide different embodiments for displaying the newly received content and buffer content. The processes depicted in FIGS. 14A-C are different embodiments of implementing step 866 of FIG. 13.

In step 902 of FIG. 14A, mobile client 126 determines whether there is any content in its local non-volatile storage buffer (e.g., non-volatile storage 280). If not, then in step 904 mobile client 126 will display the newly received content. If there is content in the buffer (step 902), then mobile client 126 will store the newly received content in its local non-volatile storage buffer in step 906 and display the oldest content in the local non-volatile storage buffer in step 908. Thus, the embodiment of FIG. 14A contemplates that after the trigger condition has completed, the mobile client 126 will treat the video as if it has been paused at the time the trigger condition started and then start playing the video again at normal speed at the point when it was paused.

FIG. 14B provides an embodiment where, after the trigger condition is reverted, mobile client 126 will consider the video to have been paused. At that point, mobile client 126 will start playing the video at the point it was paused. However, the video will be played at a fast speed until the video catches up to live video. After the video catches up to live video, the video will be displayed at normal speed (e.g. real time with respect to when it is received, regardless of whether the video is live video). In step 922 of FIG. 14B, mobile client 126 will determine whether there is any content stored in the local non-volatile storage buffer (e.g., non-volatile storage 280). If not, then in step 924, mobile client 126 will display the newly received content at normal speed. If there was content in the local non-volatile storage buffer (step 922), then in step 926, mobile client 126 will store the newly received content in its local non-volatile storage buffer. In step 928, mobile client 126 will display the oldest content stored in the local non-volatile storage buffer. This display of content will be performed at a faster speed than the normal speed used in step 924.

The process of FIG. 14C provides an embodiment where the mobile client 126 will simultaneously transmit new content and old content after a trigger condition has been reverted. In step 952, mobile client 126 will determine whether there is any content in the local non-volatile storage buffer (e.g., non-volatile storage 280). If there is no content in the local non-volatile storage buffer, then mobile client 126 will display the newly received content via user interface 276. If there was content in the local non-volatile storage buffer (step 952), then mobile client 126 will display the newly received content and the stored content separately and simultaneously. For example, if the content is video, two separate windows can be displayed on mobile client 126. In step 956, the newly received content will be displayed in the first window. In step 958, buffer content will be displayed in a second window.

One embodiment includes obtaining content at a first location, storing at least a subset of the created content in non-volatile storage at the first location and transmitting at least a portion of the content stored in the non-volatile storage to a remote entity via a network in response to a trigger. The content is created at the first location.

One embodiment includes obtaining content at a first location, transmitting at least a portion of the content from the first location to a remote entity via a network if a trigger condition does not exist, storing at least a subset of the content in non-volatile storage at the first location when the trigger conditions exists, and transmitting at least some of the content stored in the non-volatile storage to the remote entity via the network when the trigger condition no longer exists. The content is created at the first location.

One embodiment includes obtaining content at a first location, transmitting a first version of the content from the first location to a remote entity via a network in the absence of a trigger, storing a second version of the content in non-volatile storage at the first location, transmitting at least subset of second version of the content stored in the non-volatile storage to the remote entity via the network in response to the trigger. The content is created at the first location.

One embodiment includes a sensor at a first location, a communication interface at the first location, an interface to non-volatile storage at the first location, and a processor at the first location. The communication interface provides for communication with a network. The processor is in communication with the communication interface, the interface to non-volatile storage and the sensor. The processor receives newly created content from the sensor and stores the newly created content in non-volatile storage connected to the interface. The processor transmits at least a portion of the content stored in the non-volatile storage to a remote entity via the communication interface in response to a trigger.

One embodiment includes receiving content wirelessly on a mobile computing device, presenting at least a first subset of the content via a user interface in real time with respect to receiving the content prior to a trigger condition, receiving a notification wirelessly on the mobile computing device, storing at least part of the content in non-volatile storage at the mobile computing device, and (subsequent to the trigger condition) presenting content from the non-volatile storage via the user interface in delayed time with respect to receiving the content. The trigger condition is in response to receipt of the notification.

One embodiment includes receiving content wirelessly on a mobile computing device, performing a function on the mobile computing device, and (prior to performing the function) presenting at least a first subset of the content via a user interface in real time with respect to receiving the content. The process further includes storing at least part of the content in non-volatile storage at the mobile computing device and, subsequent to performing the function, presenting at least a portion of the content from the non-volatile storage via the user interface in delayed time with respect to receiving the content. The function is unrelated to the content.

One embodiment includes a wireless communication interface that receives content, an interface to non-volatile storage, a user interface and a processor on a mobile computing device. The processor is connected to the wireless communication interface, the interface to non-volatile storage and the user interface. Prior to a trigger condition, the processor presents at least a first subset of the content via the user interface in real time with respect to receiving the content. Subsequent to the trigger condition, the processor presents content from the non-volatile storage via the user interface in delayed time with respect to receiving the content. The processor stores content in non-volatile storage via the interface. The processor receives a notification wirelessly on the mobile computing device. The trigger condition is in response to receipt of the notification.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method of selectively using local non-volatile storage in conjunction with transmission of content, comprising:
obtaining content at a first location, the content is created at the first location;
storing at least a subset of the created content in non-volatile storage at the first location; and
transmitting at least a portion of the content stored in the non-volatile storage to a remote entity via a network in response to a trigger.

2. The method of claim 1, further comprising:
capturing video using a camera, the video is the content, the obtaining content includes receiving the video.

3. The method of claim 1, wherein:
the storing of the subset of the created content is performed prior to any network transmission of the content.

4. The method of claim 1, wherein:
the non-volatile storage is a removable flash memory device.

5. The method of claim 1, wherein:
the obtaining content at the first location includes accessing video;
the trigger is the network becoming available;
the storing includes storing video while the network is unavailable;
the method further includes transmitting some of the created content to the remote entity prior to the network being unavailable; and
the transmitting at least the portion of the content stored includes transmitting the content stored while the network was unavailable in response to the network becoming available.

6. The method of claim 5, further comprising:
capturing video using a camera, the video is the content; and
identifying the trigger, the identifying is performed by the camera.

7. The method of claim 6, further comprising:
receiving a communication at the camera from the remote entity, the communication is an indication of the trigger.

8. The method of claim 1, wherein:
the obtaining content at the first location includes accessing video;
the method further comprises transmitting a first resolution version of the video to the remote entity via the network;
the storing of at least the subset of the created content in non-volatile storage includes storing a second resolution version of the video in the non-volatile storage, the second resolution version of the video is at a higher resolution than the first resolution version of the video; and
the transmitting of at least a portion of the content stored from the non-volatile storage to the remote entity includes transmitting at least a portion of the second resolution version of the video from the non-volatile storage to the remote entity in response to the trigger;

9. The method of claim 8, further comprising:
identifying something in the captured video, the identifying is the trigger.

10. A method of selectively using local non-volatile storage in conjunction with transmission of content, comprising:
obtaining content at a first location, the content is created at the first location;
transmitting at least a portion of the content from the first location to a remote entity via a network if a trigger condition does not exist;
storing at least a subset of the content in non-volatile storage at the first location when the trigger conditions exists; and
transmitting at least some of the content stored in the non-volatile storage to the remote entity via the network when the trigger condition no longer exists.

11. The method of claim 10, wherein:
the storing of the at least the subset of the content is performed prior to any network transmission of the subset of the content.

12. The method of claim 10, wherein:
the trigger condition is the network not being available for communication.

13. The method of claim 10, wherein:
the storing is only performed when the trigger conditions exists.

14. The method of claim 10, wherein:
the obtaining content at the first location includes accessing video that was created at the first location;
the trigger condition is the network not being available for communication;
the transmitting at least the portion of the content from the first location to the remote entity via the network includes transmitting video while the network is available for communication;
the storing includes storing video while the network is not available for communication; and
the transmitting at least some of the content stored in the non-volatile storage from the first location to the remote entity includes transmitting video stored while the network was not available for communication.

15. The method of claim 10, further comprising:
capturing video using a camera at the first location, the content is the video, the trigger condition is the network not being available for communication; and
determining that the trigger condition no longer exists, the determining that the trigger condition no longer exists is performed by the camera.

16. The method of claim 10, further comprising:
capturing video using a camera at the first location, the content is the video, the trigger condition is the network not being available for communication;
receiving a communication at the camera from the remote entity indicating that the trigger condition no longer exists; and
the transmitting at least some of the content stored in the non-volatile storage from the first location to the remote entity via the network is performed in response to the communication received from the remote entity.

17. The method of claim 10, wherein:
the content is video;
the trigger condition is the network not being available for communication; and
the transmitting at least some of the content stored in the non-volatile storage from the first location to the remote entity includes transmitting video stored in the non-volatile storage as a first stream and live video as a second stream.

18. The method of claim 10, wherein:
the creating is video;
the trigger condition is the network not being available for communication; and
the transmitting at least some of the content stored in the non-volatile storage to the remote entity includes storing live video in the non-volatile storage and transmitting video stored in the non-volatile storage oldest to newest at a faster rate than the creating of content until video being transmitted is live video.

19. The method of claim 10, wherein:
the non-volatile storage is a removable flash memory device.

20. A method of selectively using local non-volatile storage in conjunction with transmission of content, comprising:
obtaining content at a first location, the content is created at the first location;
transmitting a first version of the content from the first location to a remote entity via a network in the absence of a trigger;
storing a second version of the content in non-volatile storage at the first location; and
transmitting at least subset of second version of the content stored in the non-volatile storage from the first location to the remote entity via the network in response to the trigger.

21. The method of claim 20, further comprising:
identifying something in the captured video, the identifying is the trigger.

22. The method of claim 20, further comprising:
the trigger is a preset time.

23. The method of claim 20, further comprising:
the trigger is a request from the remote entity.

24. An apparatus that can selectively use local non-volatile storage in conjunction with transmission of content, comprising:
a communication interface at a first location, the communication interface provides for communication with a network;
an interface to non-volatile storage at the first location; and
a processor at the first location that is in communication with the communication interface, the interface to non-volatile storage and the sensor;
wherein the processor receives newly created content from a sensor at the first location and stores the newly created content in non-volatile storage connected to the interface to non-volatile storage, the processor transmits at least a portion of the content stored in the non-volatile storage from the first location to a remote entity via the communication interface in response to a trigger.

25. The apparatus of claim 24, wherein:
the content is video;
the trigger is the network becoming available;
the processor stores the video in the non-volatile storage while the network is unavailable;
the processor transmits some of the created content prior to the network being unavailable; and
the processor transmits at least the portion of the content stored by transmitting the content stored while the network was unavailable in response to the network becoming available.

26. The apparatus of claim 25, wherein:
the processor identifies the trigger.

27. The apparatus of claim 24, wherein
the content is video;
the processor transmits a first resolution version of the video to the remote entity via the communication interface and the network;
the processor stores the video in non-volatile storage by storing a second resolution version of the video in the non-volatile storage, the second resolution version of the video is at a higher resolution than the first resolution version of the video; and
the processor transmits at least the portion of the content stored by transmitting at least a portion of the second resolution version of the video from the non-volatile storage to the remote entity in response to the trigger.

28. The apparatus of claim 27, wherein:
the processor identifies something in the captured video, the identifying is the trigger.

29. A method of selectively using local non-volatile storage in conjunction with transmission of content, comprising:
receiving content wirelessly on a mobile computing device;
prior to a trigger condition, presenting at least a first subset of the content via a user interface in real time with respect to receiving the content;
receiving a notification wirelessly on the mobile computing device, the trigger condition is in response to receipt of the notification;
storing at least part of the content in non-volatile storage at the mobile computing device; and
subsequent to the trigger condition, presenting content from the non-volatile storage via the user interface that is delayed in time with respect to when it was received.

30. The method of clam 29, wherein:
the trigger condition includes the performance of a voice connection.

31. The method of claim 29, further comprising:
reporting of the notification via the user interface, the notification alerts to a voice connection; and
the trigger condition starts at reporting of the notification and ends at conclusion of the voice connection.

32. The method of claim 29, wherein:
the trigger condition is a termination of a voice connection.

33. The method of claim 29, wherein:
the trigger condition includes performance of a voice connection; and
the storing of at least part of the content in non-volatile storage at the mobile computing device is performed only during the trigger condition.

34. The method of claim 29, wherein:
the presenting content from the non-volatile storage via the user interface in delayed time includes playing video starting from a time that the trigger condition started.

35. The method of claim 29, wherein:
the trigger condition includes performance of a voice connection; and
the content includes video.

36. A method of selectively using local non-volatile storage in conjunction with transmission of content, comprising:
receiving content wirelessly on a mobile computing device;
performing a function on the mobile computing device, the function is unrelated to the content;
prior to performing the function, presenting at least a first subset of the content via a user interface in real time with respect to receiving the content;
storing at least part of the content in non-volatile storage at mobile computing device; and
subsequent to performing the function, presenting at least a portion of the content from the non-volatile storage via the user interface in delayed time with respect to receiving the content.

37. The method of claim 36, wherein:
the function is a voice connection; and
the content is video.

38. An apparatus that can selectively use local non-volatile storage in conjunction with transmission of content, comprising:
a wireless communication interface that receives content;
an interface to non-volatile storage;
a user interface; and
a processor on a mobile computing device that is connected to the wireless communication interface, the interface to non-volatile storage and the user interface;
wherein prior to a trigger condition the processor presents at least a first subset of the content via the user interface in real time with respect to receiving the content and subsequent to the trigger condition the processor presents content from the non-volatile storage via the user interface in delayed time with respect to receiving the content, the processor stores content in non-volatile storage via the interface to non-volatile storage, the processor receives a notification wirelessly on the mobile computing device, the trigger condition is in response to receipt of the notification.

39. The apparatus of claim 38, wherein:
the content includes video; and
the trigger condition includes the performance of a voice connection.

40. The apparatus of claim 39, wherein:
the content includes video; and
the processor presents content from the non-volatile storage via the user interface in delayed time with respect to receiving the content by playing video starting from a time that the trigger condition started.
